(19) United States
(12) Patent Application Publication
(10) Pub. No.: US 2008/0040596 A1
(43) Pub. Date: Feb. 14, 2008

(54) Embedded system and boot code auto-copy method thereof

(75) Inventors: Chih-Feng Mai, Panchiao-City (TW); Chin-Tsai Yen, Taipei (TW); Ming-Chien Yang, Taipei Shien (TW); Te-Hsien Lai, Panchiao City (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 11/702,629

(22) Filed: Feb. 6, 2007

(30) Foreign Application Priority Data
Aug. 11, 2006 (TW) 95129650

(51) Int. Cl. G06F 9/00

(52) U.S. Cl. 713/2

(57) ABSTRACT

An embedded system includes a CPU, a section-swapping control device, a memory device and a section mapping device. The CPU has a boot code initializing address. The section-swapping control device detects a boot condition of the CPU and thus outputs a swap signal. The memory device includes a first memory section and a second memory section for respectively storing a first boot code and a second boot code. The section mapping device is coupled to the CPU and the memory device. The section mapping device receives the swap signal and thus maps the boot code initializing address to an initial bit address of one of the first and second memory sections such that the CPU is booted according to one of the first and second boot codes.

This application claims the benefit of Taiwan application Serial No. 95129650, filed Aug. 11, 2006, the subject matter of which is incorporated herein by reference.

### BACKGROUND OF THE INVENTION

1. Field of the Invention

The invention relates in general to an embedded system, and more particularly to an embedded system of auto-copying a boot code.

2. Description of the Related Art

Embedded and hand-held electronic products are widely used in the current industry. The operation system boot codes of the electronic products are usually updated several times form the development to the shipment, and the problem of the incapability of booting due to the damaged boot code when the data is updated tends to occur. Once the conventional electronic product has the damaged boot code and cannot boot up, the boot code has to be rewritten using the ICE (In Circuit Emulator) by the associated person, thereby increasing the production overhead and the wastage of the manpower resource.

### SUMMARY OF THE INVENTION

It is therefore an object of the invention to provide an embedded system and a boot code auto-copy method thereof capable of effectively solving the problem of the damage caused by the data modification of the boot code in the conventional electronic product.

The invention achieves the above-identified object by providing an embedded system including a CPU, a section-swapping control device, a memory device and a section mapping device. The CPU has a boot code initializing address for booting. The CPU further outputs a boot state signal to represent a boot state of the CPU. The memory device includes a first memory section and a second memory section for respectively storing a first boot code and a second boot code. The section mapping device is coupled to the CPU and the memory device and maps the boot code initializing address to one of the first and second memory sections according to a swap signal. The section-swapping control device receives the boot state signal to detect the boot state of the CPU, and thus outputs the swap signal to control the section mapping device to make the CPU select one of the first and second boot codes as a proper boot code for booting. When the CPU boots completely according to the proper boot code, the CPU copies the proper boot code to one of the memory sections corresponding to the other one of the boot codes if the CPU judges that the first boot code is different from the second boot code.

The invention also achieves the above-identified object by providing a method of auto-copying a boot code in an embedded system. The method includes the following steps. First, a memory device having at least two memory sections for respectively storing a first boot code and a second boot code is provided. Next, a boot code initializing address is outputted to read a proper boot code selected from one of the first and second boot codes to boot the embedded system. Then, the boot code initializing address is mapped to a mapped boot code initializing address, in respond to a swap signal, to correspond to one of the two memory sections. Next, a boot state signal is received to detect a boot state of the embedded system and to judge whether the embedded system boots successfully, and the swap signal is outputted according to the boot state signal to make the embedded system select one of the first boot code and the second boot code to serve as the proper boot code and make the embedded system boot according to the proper boot code. Then, it is judged whether the first boot code is the same as the second boot code when the embedded system boots completely. Next, the proper boot code is copied to one of the memory sections corresponding to the other one of the boot codes if the first boot code is different from the second boot code.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a block diagram showing an embedded system according to a preferred embodiment of the invention.

FIG. 1B is a schematic illustration showing a memory section of a memory device of FIG. 1A.

FIG. 2 shows an embodiment of a state machine of a section-swapping control device of FIG. 1A.

FIG. 3 shows a flow chart of a boot code auto-copy method of the embedded system of FIG. 1A.

### DETAILED DESCRIPTION OF THE INVENTION

The embedded system of the invention has a memory device in which a normal boot code and a backup boot code are stored. When a CPU (Central Processing Unit) boots successfully, the normal boot code is copied as the backup boot code. When the normal boot code is damaged, the embedded system of the invention enables the CPU to boot according to the backup boot code through a section mapping device.

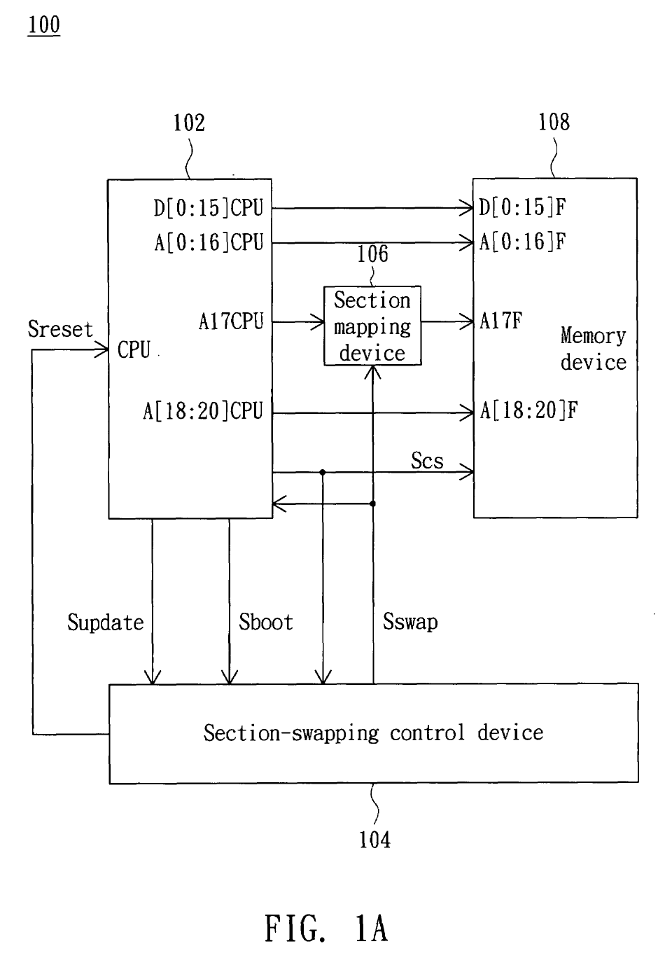

FIG. 1A is a block diagram showing an embedded system 100 according to a preferred embodiment of the invention. Referring to FIG. 1A, the embedded system 100 includes a CPU (Central Processing Unit) 102, a section-swapping control device 104, a section mapping device 106 and a memory device 108. The CPU 102 executes a booting operation of the embedded system and thus outputs a boot state signal Sboot to represent a boot state of the current system. The section-swapping control device 104 receives the boot state signal Sboot to detect a boot condition of the CPU 102 and thus generates a swap signal Sswap and outputs the swap signal Sswap to the section mapping device 106 and the CPU 102.

FIG. 1B is a schematic illustration showing a memory section 108 of a memory device of FIG. 1A. Referring to FIG. 1B, the memory device 108 includes memory sections 108a and 108b for respectively storing a normal boot code and a backup boot code. In addition, the memory device 108 may further include other memory sections for storing other information. For example, a memory section 108c may store a core program of the embedded system 100, and a memory section 108d is an unused section. The memory capacity of each of the memory sections 108a and 108b is 128K bits, while the initial bit addresses of the memory sections 108a and 108b are (0000000)₁₆ and (0010000)₁₆, respectively.

When the system boots, the CPU 102 reads a boot code from a boot code initializing address to execute the booting operation. In this embodiment, the boot code initializing address of the CPU 102 is the initial bit address (0000000)₁₆ of the memory section 108a.

The section mapping device 106 is coupled to the CPU 102 and the memory device 108. The section mapping device 106 converts the boot code initializing address outputted from the CPU 102.

The section mapping device 106 enables the CPU 102 to boot according to one of the normal and backup boot codes stored in the memory section according to the selection of the swap signal Sswap. The section mapping device 106 further outputs a reset signal Srest to the CPU 102 to reset the CPU 102.

Before the CPU 102 boots, the boot state signal Sboot and the swap signal Sswap have initial levels. When the CPU 102 boots successfully according to one of the normal and backup boot codes, the CPU 102 converts the boot state signal Sboot into a stop level. After the CPU boots successfully according to one of the normal and backup boot codes, the CPU 102 judges whether the normal boot code is the same as the backup boot code. If not, the CPU 102 executes the boot code backup operation to copy one of the normal and backup boot codes to the memory section in which the other one of the normal and backup boot codes is stored.

The CPU 102 further outputs a chip select signal Scs and an update signal Supdate to the memory device 108 and the section-swapping control device 104. The update signal Supdate has the initial level before the CPU 102 boots.

The CPU 102 includes a plurality of address pins and data pins for accessing the data in the memory device 108. This embodiment is illustrated by taking data pins D[0:15]CPU and address pins A[0:20]CPU of the CPU 102 as an example. So, the memory device 108 also includes data pins D[0:15]F and address pins A[0:20]F corresponding thereto. In this embodiment, one address pin of the address pins A[0:20]CPU is, for example, coupled to the section mapping device 106 and coupled to one corresponding pin of the address pins A[0:20]F through the section mapping device 106, and other pins of the position pins A[0:20]CPU are respectively coupled to corresponding pins of the address pins A[0:20]F. In this embodiment, illustration is made by taking the address pin A17CPU, which is coupled to the address pin A17F through the section mapping device 106, as an example.

In this embodiment, the section mapping device 106 is, for example, an XOR (Exclusive OR) gate, the swap signal Sswap is a digital signal, the initial level of the swap signal Sswap is the low level, and a swap level of the swap signal Sswap is a high level. When the swap signal Sswap has the low level, the XOR gate performs no special logic operation to the signal of the address pin A17CPU. At this time, if the CPU 102 tends to boot, the XOR gate maps the boot code initializing address (0000000)₁₆ to the initial bit address (0000000)₁₆ of the memory section 108a. Thus, the CPU 102 can boot according to the normal boot code stored in the memory section 108a.

When the swap signal Sswap has the high level, the XOR gate is substantially an inverter with respect to the signal of the address pin A17CPU. At this time, if the CPU 102 tends to boot, the XOR gate converts the signal of the address pin A17CPU from the low level 0 into the high level 1. That is, the XOR gate converts the boot code initializing address (0000000)₁₆ into a swap boot code initializing address (0010000)₁₆, which is mapped to the initial bit address (0010000)₁₆ of the memory section 108b such that the CPU 102 can boot according to the backup boot code stored in the memory section 108b.

It is to be noted that at least one or even all of the address pins of the CPU 102 may be coupled to corresponding address pin or pins of the memory device 108 through the section mapping device 106 in other embodiments according to the principle mentioned in the above-mentioned embodiment. In addition, the section mapping device 106 may be implemented using a logic circuit to achieve the object of mapping to one of the memory sections of the memory device 108 in response to the swap signal Sswap. In addition, the principle of the above-mentioned embodiment may also be applied to the CPU having address pins and data pins different from those of the CPU 102 in number.

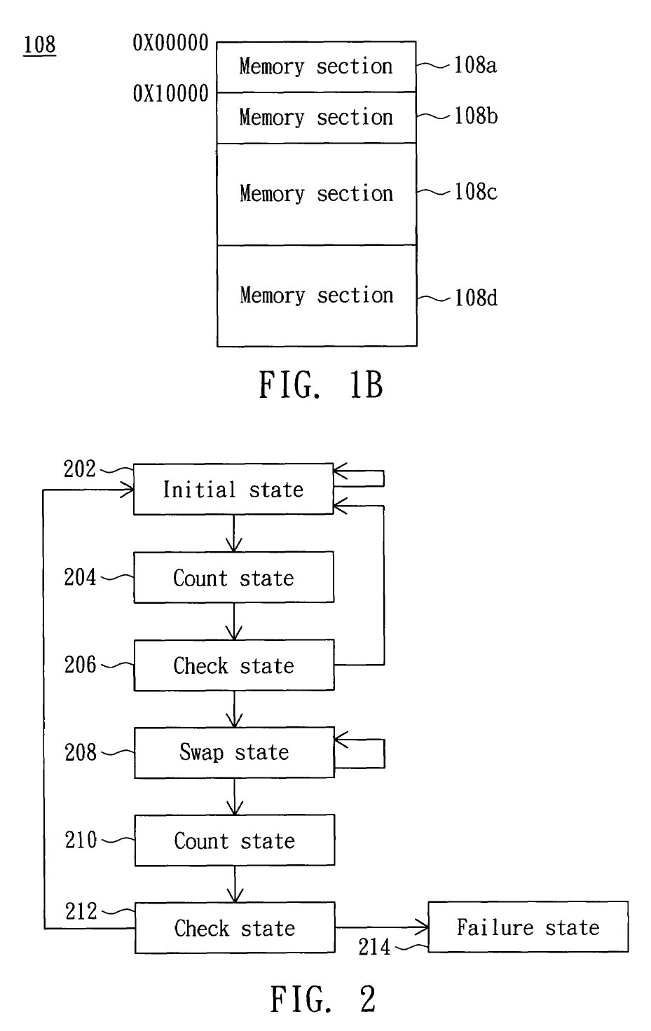

FIG. 2 shows an embodiment of a state machine of the section-swapping control device 104 of FIG. 1A. Referring to FIG. 2, the section-swapping control device 104 includes an initial state 202, count states 204 and 210, check states 206 and 212, a swap state 208 and a failure state 214.

When the embedded system 100 is powered on, the section-swapping control device 104 enters the initial state 202 to judge whether the condition that the boot state signal Sboot has the initial levels, the update signal Supdate has the initial levels and the chip select signal Scs is at a negative edge is established. If not, the section-swapping control device 104 is kept in the initial state 202. Meanwhile, the swap signal Sswap also has the initial level to enable the section mapping device 106 to map the boot code initializing address (0000000)₁₆ of the CPU 102 to the initial bit address (0000000)₁₆ of the memory section 108a such that the CPU 102 boots according to the normal boot code.

When the boot state signal Sboot and the update signal Supdate have the initial levels and the chip select signal Scs has the negative edge, the section-swapping control device 104 enters the count state 204 to perform a count operation for delaying a specific period of time. In this specific period of time, the CPU 102 boots according to the normal boot code.

When the section-swapping control device 104 finishes counting, the section-swapping control device 104 enters the check state 206 to judge the level of the boot state signal Sboot. If the boot state signal Sboot has the stop level, it means that the CPU 102 boots completely according to the normal boot code and converts the boot state signal Sboot into the stop level and the CPU 102 executes the backup operation of the boot code. At this time, the section-swapping control device 104 goes back to the initial state 202.

If the boot state signal Sboot has the initial level, it means that the normal boot code is damaged and the booting procedure has to be performed according to the backup boot code. At this time, the section-swapping control device 104 enters the swap state 208 to output a reset signal Sreset to the CPU 102 to reset the CPU 102. The section-swapping control device 104 converts the level of the swap signal Sswap into the swap level.

Next, the section-swapping control device 104 again judges whether the condition that the boot state signal Sboot has initial level, the update signal Supdate has the initial level and the chip select signal Scs is at the negative edge is established. If not, the section-swapping control device 104 is kept on the swap state 208. Meanwhile, because the swap signal Sswap has the swap level, the section mapping device 106 maps the boot code initializing address (0000000)₁₆ of the CPU 102 to the initial bit address (0010000)₁₆ of the memory section 108_{b}, and makes the reset CPU 102 boot according to the backup boot code stored in the memory section 108_{b}.

When the boot state signal Sboot and the update signal Supdate have the initial levels and the chip select signal Scs has the negative edge, the section-swapping control device 104 enters the count state 210. The section-swapping control device 104 also performs the count operation to delay a specific period of time in the count state 210. In this specific period of time, the CPU 102 boots according to the backup boot code.

When the section-swapping control device 104 finishes counting, the section-swapping control device 104 enters the check state 212 to judge the level of the boot state signal Sboot. If the boot state signal Sboot has the stop level, it means that the CPU 102 boots completely according to the backup boot code so as to convert the level of the boot state signal Sboot into the stop level. The CPU 102 also executes the backup operation of the normal and backup boot codes. At this time, the section-swapping control device 104 outputs the reset signal Sreset to the CPU 102 to reset the CPU 102 and the section-swapping control device 104 goes back to the initial state 202.

If the boot state signal Sboot still has the initial level, it means that the backup boot code is also damaged. At this time, the section-swapping control device 104 enters the failure state 214, in which only the ICE can be used to repair the boot code.

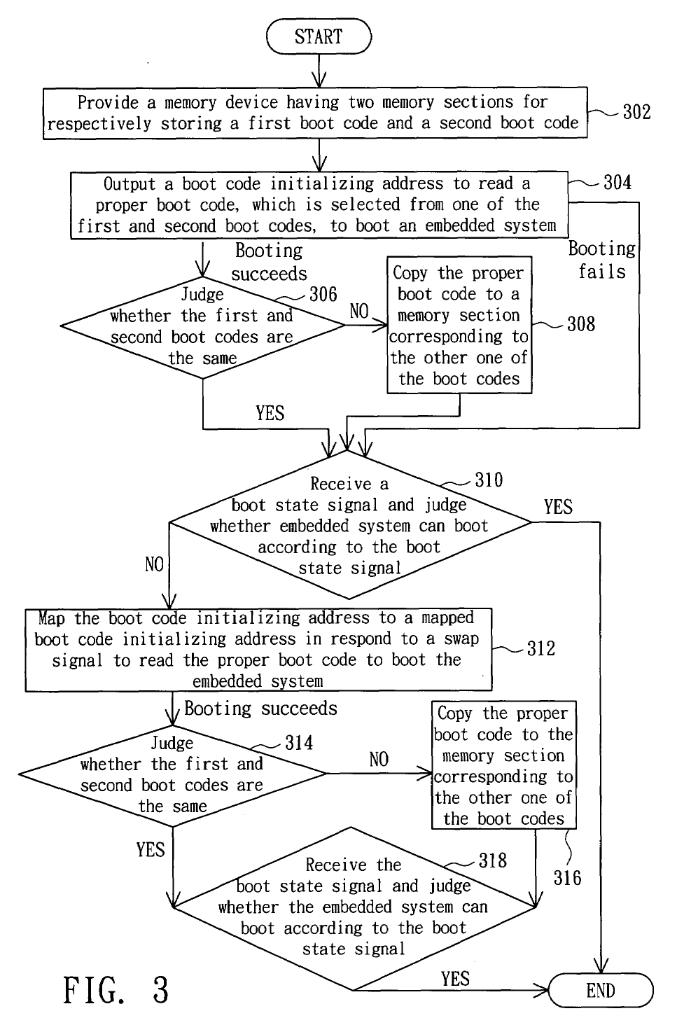

FIG. 3 shows a flow chart of a boot code auto-copy method of the embedded system 100 of FIG. 1A.

First, step 302 provides the memory device 108 having the memory sections 108a and 108b for respectively storing the normal boot code and the backup boot code. Next, step 304 outputs the boot code initializing address to read the proper boot code to execute the booting operation of the embedded system 100 and outputs the boot state signal Sboot according to the boot state of the embedded system 100. At this time, the proper boot code is the normal boot code. When the embedded system 100 boots successfully, step 306 is executed. When the booting of the embedded system 100 fails, step 310 is executed.

Then, step 306 judges whether the normal and backup boot codes are the same. If not, step 308 is executed. If yes, step 310 is executed. The other one of the normal and backup boot codes is the backup boot code. Next, step 308 copies the proper boot code to the memory section 108b corresponding to the backup boot code when the proper boot code is different from the backup boot code.

Then, step 310 receives the boot state signal Sboot and judges whether the embedded system 100 can boot according to the boot state signal Sboot. When the embedded system 100 fails in booting, step 312 is executed. When the embedded system 100 boots successfully, the method of the embodiment ends.

Next, step 312 maps the boot code initializing address to a mapped boot code initializing address, in respond to the swap signal Sswap, to read the proper boot code to execute the booting operation of the embedded system 100. At this time, the proper boot code is the backup boot code. When the embedded system 100 boots successfully, step 314 is executed.

Then, step 314 judges whether the normal and backup boot codes are the same. If not, step 316 is executed. If yes, step 318 is executed. The other one of the normal and backup boot codes is the normal boot code.

Next, step 316 copies the proper boot code to the memory section 108a of the normal boot code when the proper boot code is different from the normal boot code.

Thereafter, step 318 receives the boot state signal Sboot and judges whether the embedded system 100 can boot according to the boot state signal Sboot. When the embedded system 100 boots successfully, the method of this embodiment ends.

In this embodiment, the section-swapping control device 104 and the section mapping device 106 are independent structures. However, the section mapping device 106 disclosed in the embodiment may also be integrated in the section-swapping control device 104. The section-swapping control device 104 of this embodiment may be, for example, a CPLD (Complex Programmable Logic Device), and the memory device 108 may be, for example, a flash memory. In this embodiment, the boot state signal Sboot and the update signal Supdate are the digital signals having the high initial level.

In this embodiment, the CPU 102 includes multiple GPIO (General Purpose Input Output) pins and the CPU 102 outputs the update signal Supdate and the boot state signal Sboot to the section-swapping control device 104 and receives the swap signal Sswap through three GPIO pins, respectively. In this embodiment, the CPU 102 judges whether the normal and backup boot codes are the same according to the check sums of the normal and backup boot codes.

The embedded system of the invention includes the memory device for storing two sets of boot codes and provides the swap signal through the section-swapping control device to enable the CPU to boot by reading the backup boot code through the section mapping device when the normal boot code is damaged. The CPU of the invention can further perform the backup operation of the boot code. When the booting operation succeeds, the currently used boot code is copied to the other boot code. Thus, the embedded system of the invention can effectively solve the prior art drawback of manually repairing the system once the boot code is damaged. So, the embedded system of the invention has the advantage of reducing the manpower resource and the production overhead, which have to be paid due to the damage of the boot code.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An embedded system, comprising:
a CPU (Central Processing Unit) having a boot code initializing address, wherein the CPU for booting and outputting a boot state signal to represent a boot state of the CPU;
a memory device, which comprises:
a first memory section for storing a first boot code; and
a second memory section for storing a second boot code;
a section mapping device, which is coupled to the CPU and the memory device and maps the boot code initializing address to one of the first and the second memory sections according to a swap signal; and
a section-swapping control device for receiving the boot state signal, detecting the boot state of the CPU, and thus outputting the swap signal to control the section mapping device to make the CPU boot according to one of the first boot code and the second boot code, which serves as a proper boot code,
wherein when the CPU boots completely according to the proper boot code, the CPU copies the proper boot code to one of the first and second memory sections corresponding to the other one of the first and second boot codes if the CPU judges that the proper boot code is different from the other one of the boot codes.

2. The system according to claim 1, wherein the section mapping device maps the boot code initializing address to one of an initial bit address of the first memory section for storing the first boot code and an initial bit address of the second memory section for storing the second boot code.

3. The system according to claim 1, wherein when the section-swapping control device detects that the CPU cannot boot, the section-swapping control device swaps a level of the swap signal to control the section mapping device to make the CPU boot according to the other one of the first and second boot codes.

4. The system according to claim 1, wherein when the CPU boots completely according to the boot code, the CPU executes comparison software to determine whether a check sum of the proper boot code is equal to a check sum of the other one of the boot codes by way of comparison so as to judge whether the proper boot code is equal to the other one of the boot codes.

5. The system according to claim 4, wherein when the CPU boots completely according to the proper boot code, the CPU copies the proper boot code to one of the memory sections corresponding to the other one of the boot codes if the CPU judges that the first boot code is different from the second boot code.

6. The system according to claim 1, wherein the section mapping device is an XOR gate (Exclusive OR gate).

7. The system according to claim 1, wherein the section-swapping control device is a CPLD (Complex Programmable Logic Devices).

8. The system according to claim 7, wherein the section mapping device is integrated in the CPLD.

9. A method of auto-copying a boot code in an embedded system, the method comprising the steps of:
providing a memory device having at least two memory sections for respectively storing at least one first boot code and a second boot code;
outputting a boot code initializing address to read a proper boot code, which is selected from one of the first and second boot codes, to boot the embedded system;
mapping the boot code initializing address to a mapped boot code initializing address, in respond to a swap signal, to correspond to one of the at least two memory sections;
receiving a boot state signal to detect a boot state of the embedded system and to judge whether the embedded system boots successfully, and outputting the swap signal according to the boot state signal to make the embedded system select one of the at least one first boot code and the second boot code to serve as the proper boot code and make the embedded system boot according to the proper boot code;
judging whether the at least one first boot code is the same as the second boot code when the embedded system boots completely; and
copying the proper boot code to one of the memory sections corresponding to the other one of the boot codes if the at least one first boot code is different from the second boot code.

10. The method according to claim 9, wherein in the step of receiving the boot state signal:
when it is detected that the embedded system boots successfully, a signal level of the swap signal is an initial level; and
when it is detected that the embedded system fails in booting, the signal level of the swap signal is a swap level.

11. The method according to claim 9, wherein when the embedded system boots completely, comparison software is executed to judge whether a check sum of the first boot code is equal to a check sum of the second boot code to judge whether the first boot code is equal to the second boot code.
